(19) United States
(12) Patent Application Publication
(10) Pub. No.: US 2015/0369685 A1
(43) Pub. Date: Dec. 24, 2015

(54) METHOD FOR DETERMINING THE OPENING POINT OF A VALVE

(71) Applicants: CONTINENTAL AUTOMOTIVE FRANCE, Toulouse (FR); CONTINENTAL AUTOMOTIVE GmbH, Hannover (DE)

(72) Inventors: Thierry COLLET, Fontenilles (FR); Roland HAUFLER, Regensburg (DE)

(21) Appl. No.: 14/743,643

(22) Filed: Jun. 18, 2015

(30) Foreign Application Priority Data
Jun. 19, 2014 (FR) 1455636

(51) Int. Cl. G01L 23/24

(52) U.S. Cl. CPC G01L 23/24

(57) ABSTRACT

Disclosed is a method for determining the opening point PO of a two-position valve (1) controlled by a pulse width-modulated signal (6), the method including the following steps: controlling the valve (1) by a pulse width-modulated test signal ST having a duty cycle R growing as a function of time T; and detecting an opening of the valve (1) by observation of a variation in the time of a detection signal S provided by a pressure signal (7) measured by a pressure sensor (2) arranged in a pipe (4, 5) connected to the valve (1) and noted at a moment to of the variation of the detection signal S, the opening point PO being the duty cycle R of the test signal ST at the noted moment to.

### FIELD OF THE INVENTION

The present invention relates to the control of a two-position valve by a pulse width-modulated signal. More particularly, the invention relates to a method for determining the opening point of such a valve.

### BACKGROUND OF THE INVENTION

It is known, in order to control a two-position valve proportionally, to use a pulse width-modulated signal. Such a valve is typically returned into a position by default, for example closed, and can be controlled into another position, for example open, by means of a control signal. Due to the presence of a return means, frictional forces to be overcome, or other reasons, it is necessary for the control signal to exceed a certain minimum value, referred to as the opening point, so that the valve opens. This opening point, or minimum value of the control signal is, in the case of a pulse width-modulated signal, a minimum duty cycle or open duty cycle.

It is indispensable to know precisely this opening point so as to be able to model the behavior of the valve and, for example, so as to be able to precisely estimate the flow passing through said valve.

### SUMMARY OF THE INVENTION

The invention relates to a method for determining the opening point of a two-position valve controlled by a pulse width-modulated signal, the method comprising the following steps: controlling the valve by a pulse width-modulated test signal having a duty cycle growing as a function of time, detecting an opening of the valve by observation of a variation in the time of a detection signal provided by a pressure signal, which is measured by a pressure sensor arranged in a pipe connected to the valve and which is noted at a moment of said variation of the pressure signal, the opening point being the duty cycle of the test signal at said noted moment.

In accordance with another feature of the invention, the test signal is such that the duty cycle thereof grows in stages so as to have a constant value for the duration of a measurement, this duration advantageously being between 1 and 4 seconds, preferably equal to 2 seconds.

In accordance with another feature of the invention, the method also comprises a preliminary step of measurement by the pressure sensor in the absence of control, so as to learn the noise, the detection signal being indicative of the measured pressure signal deprived of said learned noise.

In accordance with another feature of the invention, the frequency of the test signal is such that a signal-to-noise ratio of maximum pressure appears.

In accordance with another feature of the invention, the duty cycle of the test signal varies between a minimum value, for which a valve cannot be opened, and a maximum value, for which a valve is necessarily open.

In accordance with another feature of the invention, a test is stopped and the test signal is canceled as soon as an opening of the valve is detected.

In accordance with another feature of the invention, the pressure sensor is an existing pressure sensor.

In accordance with another feature of the invention, the detection signal is obtained by frequency analysis of said pressure signal, preferably previously deprived of the learned noise.

In accordance with another feature of the invention, the method comprises n repetitions: control of the valve by a test signal and determination of the opening point, followed by a calculation of an average of the n opening points thus determined, with n between 2 and 10, preferably equal to 5.

In accordance with another feature of the invention, the method is applied in a phase in which the variation of the measured pressure remains low.

In accordance with another feature of the invention, the method is applied to a bleed valve of a fuel vapor filter, and the pressure sensor is the pressure sensor of the intake manifold.

In accordance with another feature of the invention, the method is applied to a fuel injector, and the pressure sensor is the fuel pressure sensor arranged on the injector train.

### BRIEF DESCRIPTION OF THE DRAWINGS

Further features, details and advantages of the invention will become clearer upon reading the detailed description given hereinafter by way of indication with reference to the drawings, in which:

FIG. 1 schematically illustrates a valve in the environment thereof,

FIG. 2 illustrates the principle of a pulse width modulation signal,

FIG. 3 illustrates the duty cycle notion,

FIG. 4 schematically illustrates an intake circuit and a filter bleed valve,

FIG. 5 illustrates the different signals implemented over the course of the method.

### DETAILED DESCRIPTION OF THE INVENTION

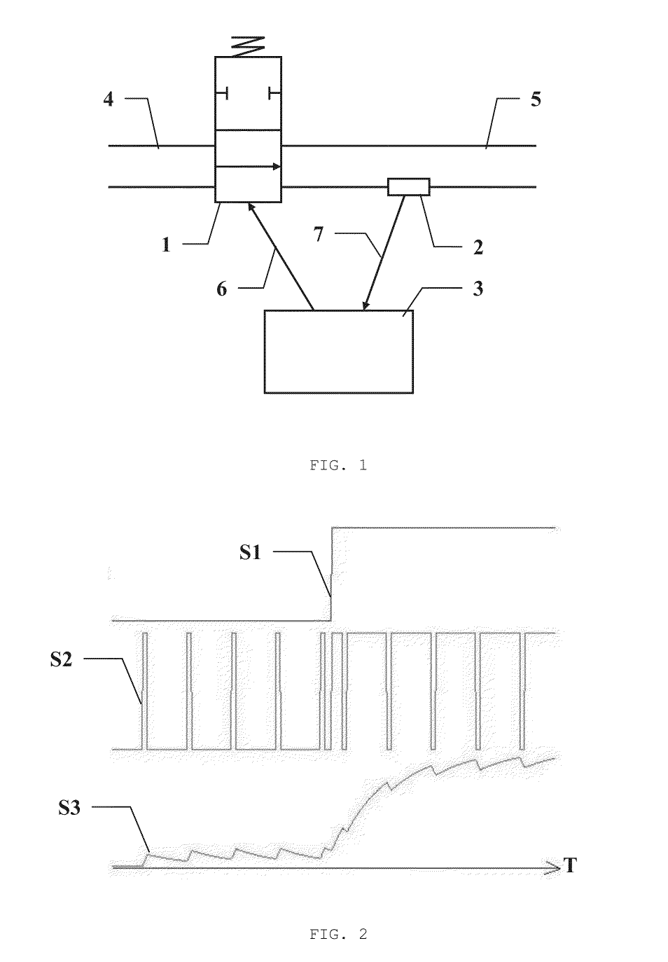

FIG. 1 illustrates a typical environment of the invention. A valve 1 is arranged between an upstream pipe 4 and a downstream pipe 5. The valve thus makes it possible to control a transfer of fluid between the two pipes 4, 5 depending on the open or closed position of said valve. The valve 1 is a two-position valve. It is typically returned into a rest position, for example a closed position, in the absence of control. A control is able to bring about a change of position of the valve 1, into the opposite position, for example an open position.

A processing unit 3 is able to perform calculations and processing operations and can selectively drive the valve 1 into the open position thereof, for example by a control, or into the closed position thereof, for example by an absence of control.

Although the valve 1 is a two-position valve, it is possible, as is known, to provide a proportional control by means of a pulse width modulation (PWM) signal 6. A PWM signal 6 is an all-or-nothing signal. The principle lies in modulating the duration for which the PWM signal 6 is in the high state. Thus, a temporal proportionality is provided so as to simulate an amplitude proportionality.

This is illustrated in FIG. 2, which comprises three signal curves over time T. The upper curve S1 is the signal to be applied, here a step. The median curve S2 is the corresponding PWM signal. The lower curve S3 is the signal as received by a load, providing an integration in time, of the PWM signal S2 and which essentially reproduces the signal S1.

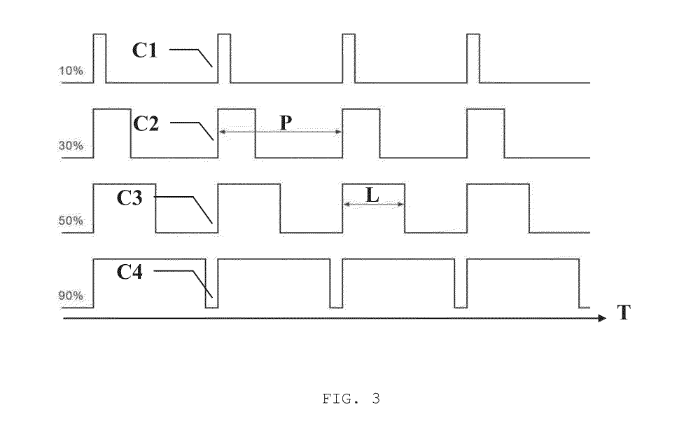

An important variable for characterizing a PWM signal is the duty cycle R. A PWM control is generally discretized over time intervals or periods P, defining a frequency F. The duty cycle R is defined for each period as the time ratio L in which the signal is in the high state over the total time of the period P, R=100×L/P. This ratio is multiplied by 100 so as to be expressed as a percentage. FIG. 3 illustrates, from top to bottom, four curves C1-C4 as a function of time T having, respectively, duty cycles R as follows:
curve C1: R=10%,
curve C2: R=30%,
curve C3: R=50%,
curve C4: R=90%.

When a valve 1 is controlled by a PWM signal 6, the duration of opening of said valve is substantially proportional to the duty cycle R. A fluid flow passing through the valve 1 can thus be estimated on the basis of the opening time, on the basis of the duty cycle R, and on the basis of other factors, such as the maximum flow that can pass through the valve 1, the differential pressure between the upstream pipe 4 and the downstream pipe 5, or also the fluid type, temperature, etc.

However, due to the presence of a return means, frictional forces to be overcome, or other reasons, a valve 1 in practice only opens when the duty cycle R of the control signal 6 exceeds a certain minimum value, referred to as the opening point PO. Also so that any derived model, such as a flow estimator, is precise, or for other applications, it is necessary to know precisely the opening point PO of a valve 1 or the minimum duty cycle R on the basis of which the valve 1 effectively opens.

The invention relates to a particularly effective, rapid and precise method making it possible to determine an opening point PO for a given valve 1. This method requires the ability to control the valve 1 and to provide a pressure measurement 7 in the pipe 4, 5, preferably at a point close to the valve 1. In numerous applications and particularly the envisaged applications, a pressure sensor 2 able to provide such a pressure signal 7 is already available and advantageously can be reused. Another advantage of the method according to the invention is the ability to be implemented in situ, the valve 1 being in its working environment.

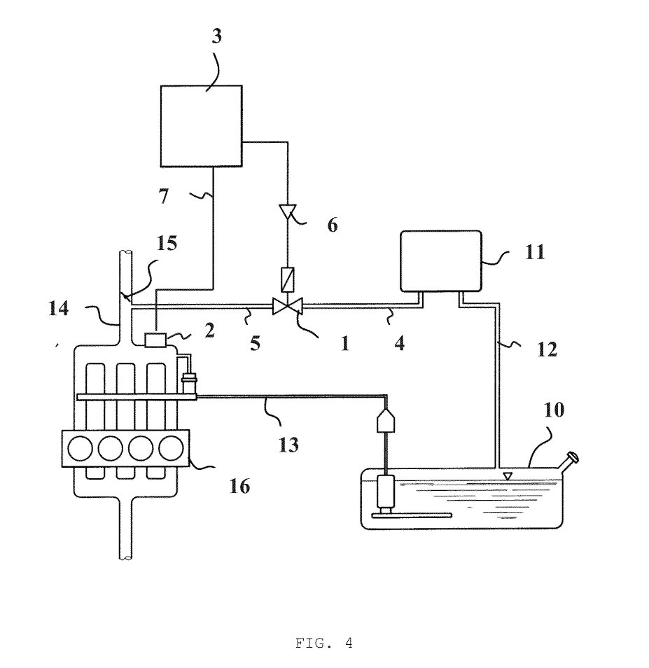

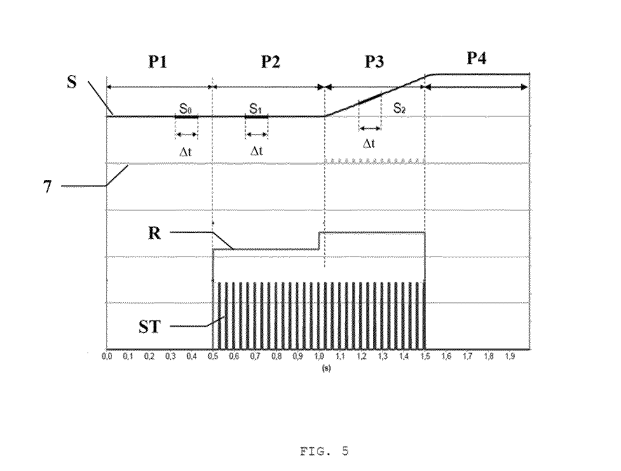

A particular application of the invention is the characterization of a bleed valve of a fuel vapor filter for a motor vehicle. As illustrated in FIG. 4, which shows a partial schema of the fuel supply system of a motor vehicle 16, a vapor filter 11, also referred to as a canister 11, is associated with a fuel tank 10. The filter 11 is connected to the tank 10 by a pipe 12 so as to collect and store the excess fuel vapors.

The nominal fuel intake circuit is indicated by a pipe 13 connecting the tank 10 to the engine 16, so as to supply said engine with fuel. The engine 16 also comprises a pipe 14, or intake manifold, controlled by a valve 15, which makes it possible to inject air into the engine 16.

So as to be able to clean the filter 11, it is necessary to bleed said filter. For this, an additional pipe 4, 5 connecting the filter 11 to the intake manifold 14 is added. The fuel vapors stored in the filter 11 can thus be used by the engine 16. A valve 1 makes it possible to control the bleeding of the filter 11 into the intake manifold 14 and, when said bleed valve 1 is open, to inject the fuel vapors delivered from the filter 11 into the engine 16.

A processing unit 3 controls the engine and controls the intake and also manages the filter 11. For this, the processing unit 3 controls at least the intake valve 15 by means of a control signal, and controls the bleed valve 1 by means of another control signal 6. A pressure sensor 2 is conventionally arranged in the intake manifold 14 and provides a pressure signal 7 to the processing unit 3. Further sensors (not shown) such as a temperature sensor or a fuel richness sensor, can also advantageously be interfaced with the processing unit 3.

In such a context, the load or rate of filling of the filter 11 may be unknown. The filter 11 may fill up typically when the vehicle is parked in the sun. Because contact is cut, the processing unit 3 is switched off and therefore blind. In the event of a restart, it is useful to known the load of the filter 11.

In order to estimate the load of the filter 11, the bleed valve 1 is opened progressively and the effect on a richness sensor is observed. So that such an estimation is reliable, it is necessary to precisely know the opening point PO of the valve 1. In fact, if it is believed that the valve 1 is open whilst it remains closed, no variation of richness being observed, it may be deduced that the filter 11 is empty. If, in actual fact, the filter 11 is full, an effective opening of the valve 1 will allow a large quantity of fuel to enter into the intake 14. A strong and sudden variation of the richness will then follow, which brings about a strong response of the richness controller and may lead, in certain conditions, to an engine stall.

If, by contrast, the valve 1 is open whilst it is supposed to be closed, fuel originating from the filter 11 will penetrate the intake 14, driving a compensation by the richness controller. This correction is not taken into account in the estimation of the load of the filter 11. An incorrect estimation of the quantity of fuel output by the filter 11 then follows.

It is also essential to precisely know the opening point PO of the bleed valve 1.

In accordance with the prior art, a method for determining the opening point PO of the bleed valve 1 lies in progressively controlling the bleed valve and in observing a deviation of a richness sensor or of a richness controller. Such a method has a number of disadvantages. On the one hand, so that the opening of the bleed valve 1 has an influence on richness, it is necessary for the filter 11 to be full. On the other hand, so that the influence observed on the richness is indeed caused by the bleed valve 1, it is necessary to eliminate the other possible influences on richness and therefore to proceed with a determination during a deceleration phase, in which the intake 15 is closed. In addition, because the sensitivity of the richness is relatively low, it is necessary, in order to provide a precise determination, to proceed with small increments of opening of the bleed valve 1. This leads to a relatively long determination duration, typically around 30 seconds. Such a deceleration duration is not compatible with new start-stop or hybrid systems, which reduce or eliminate the deceleration phases. Such a method also is no longer suitable nowadays.

By contrast, a method according to the invention for determining the opening point PO of a two-position valve 1 controlled by a pulse width-modulated signal 6 comprises the following steps.

The valve 1 is controlled by a pulse width-modulated test signal ST having a duty cycle R growing as a function of time T. This control is applied at least until a variation in the time of a detection signal S provided by a pressure signal 7 is observed. Such a variation is known to be indicative of an opening of the valve 1. In fact, because a pressure difference is generally present between the upstream pipe 4 and the downstream pipe 5 of the valve 1, an opening of the valve 1 produces a flow through the valve 1 that drives a variation, most often a sharp increase, of the pressure 7. The detection signal S is typically obtained by filtering the pressure signal 7 so that a variation of the detection signal S corresponds to an “effective” variation of the pressure signal 7, to the exclusion of a variation produced artificially by the measurement chain (oscillation, noise, interference, etc.).

The pressure signal 7 is typically measured by a pressure sensor 2, preferably arranged in the proximity of the valve 1. The moment of opening to, at which a variation of the detection signal S is produced, is noted. The opening point PO is then determined by the duty cycle R of the test signal ST at said noted moment to.

The test signal ST is growing so as to be sure of reaching the value PO for which the valve 1 opens. In accordance with one embodiment this growth may be strict. In accordance with an alternative preferred embodiment the test signal ST may be growing in stages so as to have a constant duty cycle R during the duration of a measurement.

Such an embodiment is particularly suitable for the use of a filter producing the detection signal S on the basis of the pressure signal 7, in that the stage during which the duty cycle R remains constant advantageously allows said filter to stabilize.

The detail of the filter used does not need to be detailed. The person skilled in the art will know, without difficulty, how to synthesize such a filter.

The duration of a measurement is between 1 and 4 seconds, preferably equal to 2 seconds.

Due to the nature of the pressure signal 7 and of the environment of the sensor 2, the pressure signal 7 may be relatively disturbed. If solely the amplitude of said signal 7 is considered, a significant variation can be observed, associated for example with interference, whilst the pressure has not significantly changed. Also, so as to overcome such insignificant artifacts, it is beneficial to estimate an average noise present over the pressure signal 7 so as not to take this into account for the detection of an opening of the valve 1.

For this, in accordance with an advantageous feature, the method comprises a preliminary step of measurement by the pressure sensor 2 in the absence of control. Also, that which is measured is not linked to the control of the valve 1 and is solely indicative of the noise. During this step, said noise is “learned”.

The noise can be learned in different ways. The principle is to be able to compare the noise thus learned with a measurement taken subsequently in the presence of a control signal so as to detect an effective variation of the measured pressure signal 7, said variation being different from the simple noise as learned.

In accordance with a preferred embodiment at least one function of the filter producing the detection signal S on the basis of the pressure signal 7 performs a subtraction that deprives the pressure signal 7 of said learned noise.

If a frequency approach is considered, the noise can be learned by a frequency characterization of the measured signal in the absence of control. Then, a variation of the measured signal in the presence of a control may or may not be retained depending on the frequency positioning thereof.

The filter used to produce the detection signal S, used to detect an opening of the valve 1, is advantageously applied to the pressure signal 7 deprived of the learned noise.

The test signal ST is a pulse width-modulated signal. It is constructed by a processing unit 3, which is usually digital. Also, the test signal ST is advantageously discretized in accordance with a recurrence associated with the recurrence of calculation of the processing unit 3. For an engine control and fuel vapor filter 11 bleed application, the recurrence of the control signal of a bleed valve 1 is typically 100 ms, that is to say a signal sampled at 10 Hz. However, in order to increase the visibility and therefore the detectability of the variation in the time observed over the detection signal S, the recurrence of the test signal ST, as used in the method for determining the opening point PO, is advantageously reduced, or the frequency thereof is increased, this being equivalent.

A value of 30 Hz is advantageously retained.

Alternatively, an optimal sampling frequency can be determined by experimentation. In this case the retained sampling frequency is that for which the variation of the pressure signal 7, or, this being equivalent, the variation of the detection signal S, has the greatest peak, or, equivalently, the frequency for which the signal-to-noise ratio of the pressure signal 7 is maximum.

In order to sweep across an operating range of the valve 1 and be sure of crossing an opening point PO of the valve 1, the test signal ST grows from a value at which the valve 1 is necessarily closed to a value at which the valve 1 is necessarily open. A simple way of providing a test signal ST satisfying these conditions is to vary the duty cycle R of the test signal ST between 0% on the one hand and 100% on the other hand.

However, such a test signal ST is not optimal in terms of the speed for reaching the opening point PO, particularly if the duty cycle R corresponding to the opening point PO is relatively high. Also, it is possible to optimize by selecting a test signal ST varying between a minimum value m %, for which a valve 1 cannot be opened, and a maximum value M %, for which a valve 1 is necessarily open. Thus, if the valves 1 used have opening points PO statistically distributed between X % and Y %, it is possible to take a minimum value m % of X−a % and a maximum value M % of Y+a %, where a is a safety margin of a few percent or a few fractions of percent. This advantageously makes it possible to focus the method around relevant values and thus to reduce the duration of the test or, for the same test duration, to increase the sensitivity of the determination.

By way of illustration, in the case of the fuel vapor filter, the used valves 1 have an opening point PO between 5 and 7%, for a control frequency of 10 Hz. Also, it is possible to adopt a minimum duty cycle m % of 4% and a maximum duty cycle of M % of 8%. By considering that a precision of determination of the opening point PO of 1% is sufficient, a complete determination, using a control signal ST varying by stages of 1%, requires at most five stages. With a measurement duration of 2 s, a determination can be performed in 10 s.

It should be noted that the use of a different control frequency does not alter the measurement time, in that a proportionality ratio is applied to the values of the duty cycle R. Thus, for a frequency of 30 Hz, that is to say three times greater, m % becomes 12%, M % becomes 24%, and the increment between one stage and the following stage becomes 3%. Also, a determination still requires at most five stages. Said determination can be performed in 10 s.

So as not to keep a valve 1 open longer than necessary to determine the opening point PO, in accordance with an alternative embodiment a test is advantageously stopped as soon as an opening of the valve 1 is detected. The stopping of the test, or equivalently a cancellation of the test signal ST, thus immediately produces a closure of the valve 1. This is advantageous in that a determination can then be performed more quickly.

An embodiment of the method will now be described with reference to FIG. 5, illustrating the different signals. FIG. 5 shows four signals as a function of time and in accordance with four phases P1-P4. From bottom to top the signals are: the control signal ST, the duty cycle signal R, the pressure signal 7 and the detection signal S provided by the pressure signal 7 by filtering and indicative of an “effective” variation of the pressure signal 7, possibly deprived of the learned noise. The variation of the detection signal S over a time interval Δt is used to detect opening of the valve 1.

The first phase P1, furthest to the left in FIG. 5, in which the control signal ST is zero, corresponding to a duty cycle R of zero, produces a substantially constant pressure signal 7. The detection signal S is determined and produces a reference value S0 indicative of the learned noise in the absence of control ST.

The duration of each of the phases P1-P4 is equal to the duration of the measurement.

During the second phase P2, the signal ST is applied with a first low value, typically the value m %. This corresponds to a duty cycle ratio R that is not zero and here is held constant over the duration of the measurement. A pressure signal 7 is measured and processed so as to obtain a value S1 of the detection signal S. Here, the value S1 is substantially equal to the reference value S0. Also, no variation indicative of an opening of the valve 1 is detected, and the detection of opening remains negative.

At the end of a new measurement duration, the third phase P3 starts. The control signal ST is modified such that the corresponding duty cycle R is increased by an increment. It can be observed over the pressure signal 7 that oscillations reproducing the oscillations of the control signal ST can be observed. It follows that the value of the detection signal S, indicative of a variation, sees its value rise. Here, this rise has the form of a ramp, due to the presence of an integrator in the processing, so as to amplify the variation. Here in a particular embodiment, the slope of the signal S is proportional to the amplitude of the pressure variation.

It follows that the value S2 of the detection signal S has a significant variation relative to the reference value S0. This is indicative of an opening of the valve 1. The value of the duty cycle R can then be noted and provides the opening point PO.

During the following phase P4, the opening point having been reached, the control signal ST can be canceled: the test sequence is terminated. The pressure signal 7 becomes substantially constant again. The detection signal S remains at its reached value, but becomes substantially constant again.

The pressure sensor 2 is, in the present method, used to detect a flow through the valve 1. Said pressure sensor can be arranged selectively in the upstream pipe 4 or in the downstream pipe 5. In accordance with a preferred embodiment, the pressure sensor 2 is advantageously arranged downstream of the valve 1.

In the envisaged cases of application a pressure sensor 2 is already present in the proximity of the valve 1 and can thus be reused advantageously.

Thus, in the case of application already described, in which the method is applied to a bleed valve 1 of a fuel vapor filter 11, the pressure sensor 2 is a pressure sensor 2 already present in the intake manifold 14 and previously installed for reasons of controlling the intake by the engine control.

Likewise, in the case of application in which the valve 1 is a fuel injector, the pressure sensor is a fuel pressure sensor arranged over the injector train, installed previously for the needs of controlling injectors by the engine control. In this latter case the pressure sensor is upstream of the injector.

In accordance with a preferred embodiment the step of observing a variation of the detection signal S indicative of a pressure variation comprises a frequency analysis of the pressure signal 7. Such an operation of spectral transformation of the pressure signal 7 makes it possible to make clearer the sought pressure variation. In addition, this operation advantageously makes the detection independent of the amplitude of the measured pressure signal 7. The method is thus conferred an improved robustness, particularly in a noisy environment. Such a frequency analysis is described for example in DE 102009033451.

A single test may be sufficient to determine the opening point PO of a valve 1 with sufficient precision. This makes it possible to determine the opening point PO within a duration at most equal to the duration of a measurement, multiplied by the measurement number, i.e. between 1 and 4 seconds, typically 2 seconds, multiplied typically by five measurements, i.e. ten seconds.

However, in order to overcome certain errors, it may be advantageous to make the method more robust by proceeding in the following manner. In a first step the basic test is repeated n times. The following is then repeated n times: control of the valve 1 by a test signal ST and determination, for each control, of an opening point value, i.e. n opening points PO. In a second step, an average of these n opening point values PO is calculated. In order to offer a certain improvement, n is at least equal to 2. So as not to uselessly lengthen the total time assigned to the method, n is at most equal to 10. A value of 5 offers a good compromise. This leads to a typical determination time of 10×5=50 seconds.

As is clear to the person skilled in the art, the described determination method can be applied advantageously to a valve 1 in situ, in a situation of operation. Thus, in the case of use of a bleed valve 1 of a filter 11, the method is advantageously applicable, the valve 1 being mounted on a vehicle.

So that the pressure sensor 2 detects a variation effectively associated with a flow caused by an opening of the valve 1, it is necessary that any other cause of variation of pressure is eliminated during the duration of the determination method.

This is generally possible, the processing unit 3 being in charge of controlling the other influential devices and being able to drive a pressure variation. Thus, in the case of application of the bleed valve 1, the processing unit 3, which controls the valve 1, is the engine control computer, which controls the valve 15 and also all the other devices influencing pressure. Also, the processing/engine control unit 3 can select the preferred moment to launch the method.

In accordance with one embodiment the determination method is preferably launched during operating phases in which the pressure is stable over time, thus any variations of pressure observed are caused by the control ST of the valve 1. These may be phases during which the intake valve 15 remains closed, such as deceleration phases. Since the latter are shortened, as has been described above, the method according to the invention is advantageous in that it can be performed in a short time.

The described method can be applied to a valve 1, so as to characterize it, once for example upon exit from the manufacturing chain, either on the bench or in situ.

If the opening point PO is at risk of changing over time, for example due to ageing, the method can be applied so as to characterize a valve 1 regularly during the service life thereof. Here, the method benefits advantageously from being able to be performed in situ.

Thus, in the case of application to a bleed valve 1, the method is advantageously applied before estimating the load of the filter 11, and thus for example each time the vehicle is started.

1. A method for determining an opening point (PO) of a two-position valve (1) by a pulse width-modulated signal (ST), the method comprising the following steps:
controlling the valve (1) by a pulse width-modulated test signal (ST) having a duty cycle (R) growing as a function of time (T),
detecting an opening of the valve (1) by observation of a variation in the time of a detection signal (S) provided by a pressure signal (7) measured by a pressure sensor (2) arranged in a pipe (4, 5) connected to the valve (1) and noted at a moment (to) of said variation of the detection signal (S), the opening point (PO) being the duty cycle (R) of the test signal (ST) at said noted moment (to).

2. The method as claimed in claim 1, wherein the test signal (ST) is such that the duty cycle (R) thereof grows in stages so as to have a constant value for the duration of a measurement.

3. The method as claimed in claim 2, wherein the duration of a measurement is between 1 and 4 seconds.

4. The method as claimed in claim 1, also comprising a preliminary step of measurement by the pressure sensor (2) in the absence of control, so as to learn the noise, the detection signal (S) being indicative of the measured pressure signal (7) deprived of said learned noise.

5. The method as claimed in claim 1, wherein the frequency of the test signal (ST) is such that a signal-to-noise ratio of the maximum pressure signal (7) appears.

6. The method as claimed in claim 1, wherein the duty cycle (R) of the test signal (ST) varies between a minimum value (m %), for which a valve (1) cannot be opened, and a maximum value (M %), for which a valve (1) is necessarily open.

7. The method as claimed in claim 1, wherein a test is stopped and the test signal (ST) is canceled as soon as an opening of the valve (1) is detected.

8. The method as claimed in claim 1, wherein the pressure sensor (2) is an existing pressure sensor.

9. The method as claimed in claim 1, wherein the detection signal (S) is obtained by frequency analysis of said pressure signal (7), preferably previously deprived of the learned noise.

10. The method as claimed in claim 1, comprising n repetitions: control of the valve (1) by a test signal (ST) and determination of the opening point (PO), followed by a calculation of an average of the n opening points (PO) thus determined, with n between 2 and 10, preferably equal to 5.

11. The method as claimed in claim 1, applied in a phase in which the variation of the measured pressure remains low.

12. The method as claimed in claim 1, applied to a bleed valve (1) of a fuel vapor filter (11), wherein the pressure sensor (2) is the pressure sensor of the intake manifold (14).

13. The method as claimed in claim 1, applied to a fuel injector, wherein the pressure sensor (2) is the fuel pressure sensor arranged on the injector train.

14. The method as claimed in claim 2, wherein the duration of a measurement is equal to 2 seconds.

15. The method as claimed in claim 2, also comprising a preliminary step of measurement by the pressure sensor (2) in the absence of control, so as to learn the noise, the detection signal (S) being indicative of the measured pressure signal (7) deprived of said learned noise.

16. The method as claimed in claim 3, also comprising a preliminary step of measurement by the pressure sensor (2) in the absence of control, so as to learn the noise, the detection signal (S) being indicative of the measured pressure signal (7) deprived of said learned noise.

17. The method as claimed in claim 2, wherein the frequency of the test signal (ST) is such that a signal-to-noise ratio of the maximum pressure signal (7) appears.

18. The method as claimed in claim 3, wherein the frequency of the test signal (ST) is such that a signal-to-noise ratio of the maximum pressure signal (7) appears.

19. The method as claimed in claim 4, wherein the frequency of the test signal (ST) is such that a signal-to-noise ratio of the maximum pressure signal (7) appears.

20. The method as claimed in claim 2, wherein the duty cycle (R) of the test signal (ST) varies between a minimum value (m %), for which a valve (1) cannot be opened, and a maximum value (M %), for which a valve (1) is necessarily open.
